(19) United States
(12) Patent Application Publication
(10) Pub. No.: US 2026/0125098 A1
(43) Pub. Date: May 7, 2026

(54) Motorized Stroller Device

(71) Applicant: Arlena Jones, Sacramento, CA (US)

(72) Inventor: Arlena Jones, Sacramento, CA (US)

(21) Appl. No.: 18/940,298

(22) Filed: Nov. 7, 2024

(51) Int. Cl. B62B 9/10; B62B 7/04

(52) U.S. Cl. CPC B62B 9/10; B62B 7/04

(57) ABSTRACT

A motorized stroller device for supporting and transporting a parent or other person while transporting a stroller includes a stroller and a hoverboard. The hoverboard is coupled to the stroller such that operation of the hoverboard moves the stroller with the hoverboard.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stroller device and more particularly pertains to a new stroller device for supporting and transporting a parent or other person while transporting a stroller.

### (2) Description of Related Art including information disclosed under 37 CFR 1.97 and 1.98

The prior art relates to stroller devices. Known prior art lacks attachment of a hoverboard to a stroller for providing motorization of movement of the hoverboard and stroller.

### BRIEF SUMMARY OF THE INVENTION

An embodiment of the disclosure meets the needs presented above by generally comprising a stroller and a hoverboard. The hoverboard is coupled to the stroller such that operation of the hoverboard moves the stroller with the hoverboard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a motorized stroller device according to an embodiment of the disclosure.

FIG. 2 is a rear view of an embodiment of the disclosure.

FIG. 3 is a front view of an embodiment of the disclosure.

FIG. 4 is a top view of an embodiment of the disclosure.

FIG. 5 is a bottom view of an embodiment of the disclosure.

FIG. 6 is a side view of an embodiment of the disclosure in use.

FIG. 7 is a detailed view of a clamp of an embodiment of the disclosure.

FIG. 8 is a detailed view of a clamp of an embodiment of the disclosure in an open position.

### DETAILED DESCRIPTION OF THE INVENTION

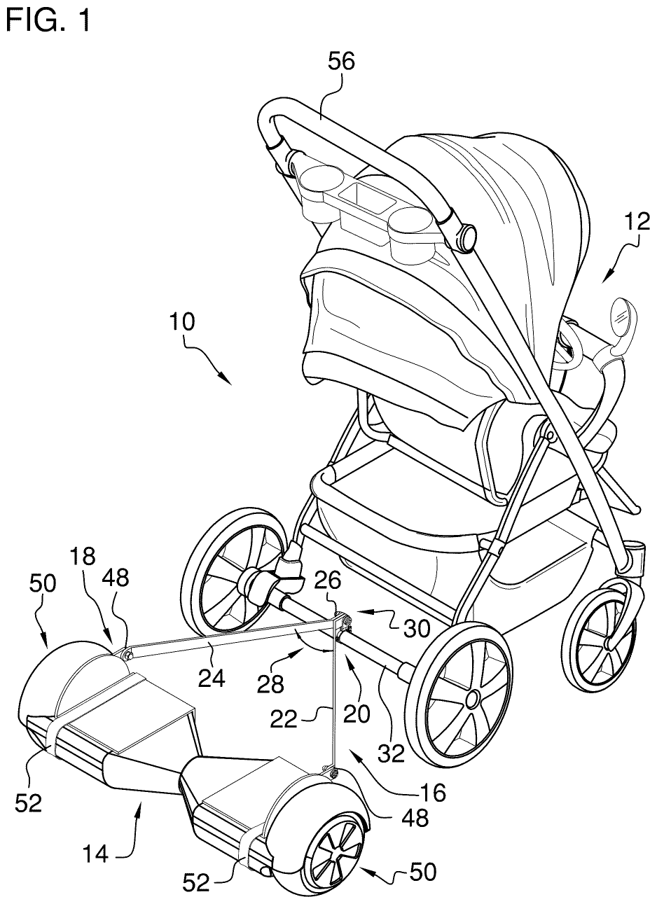

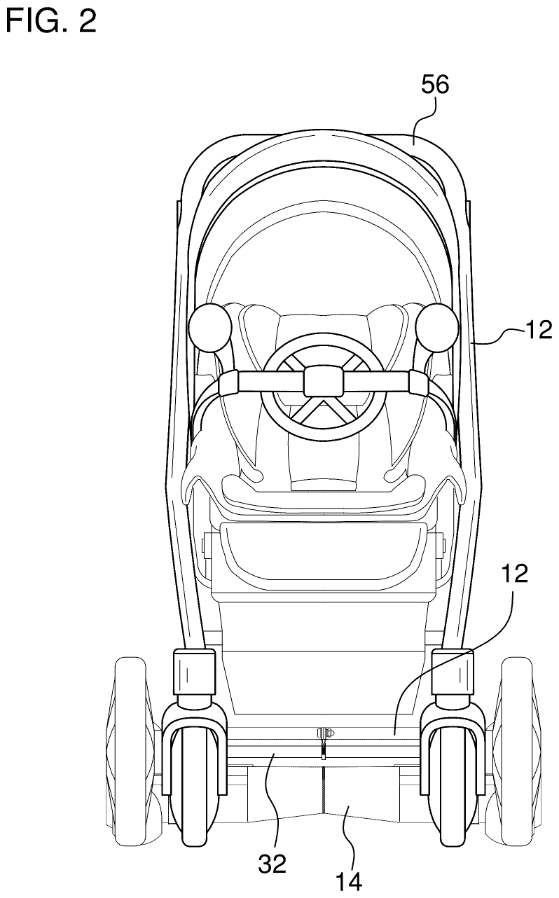

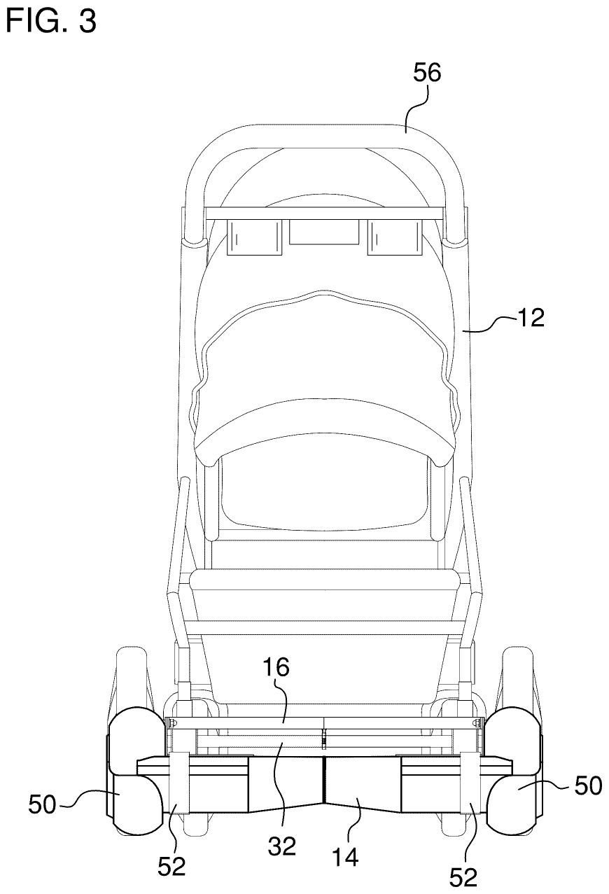

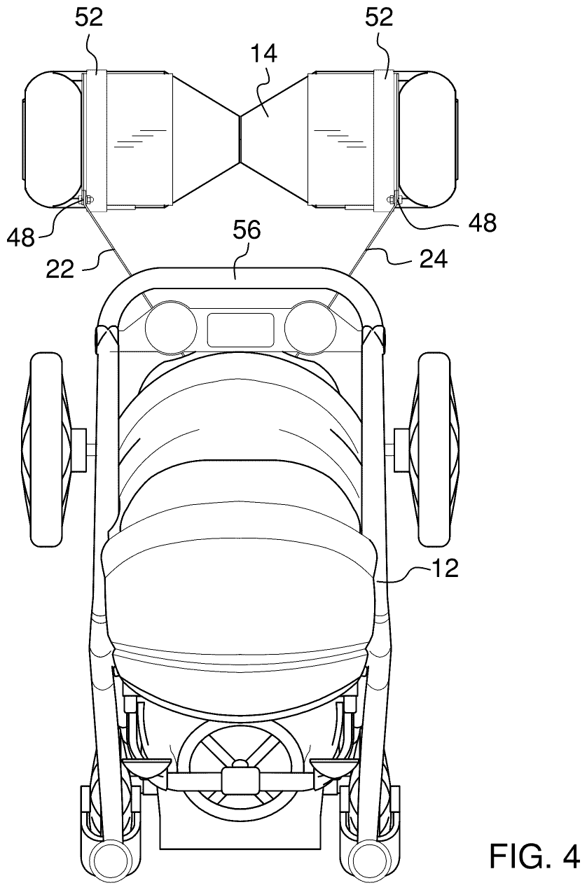

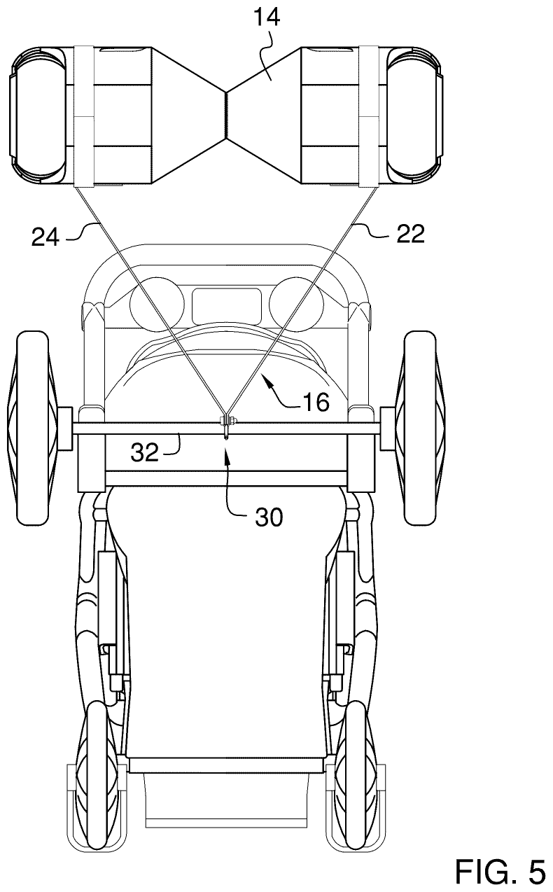

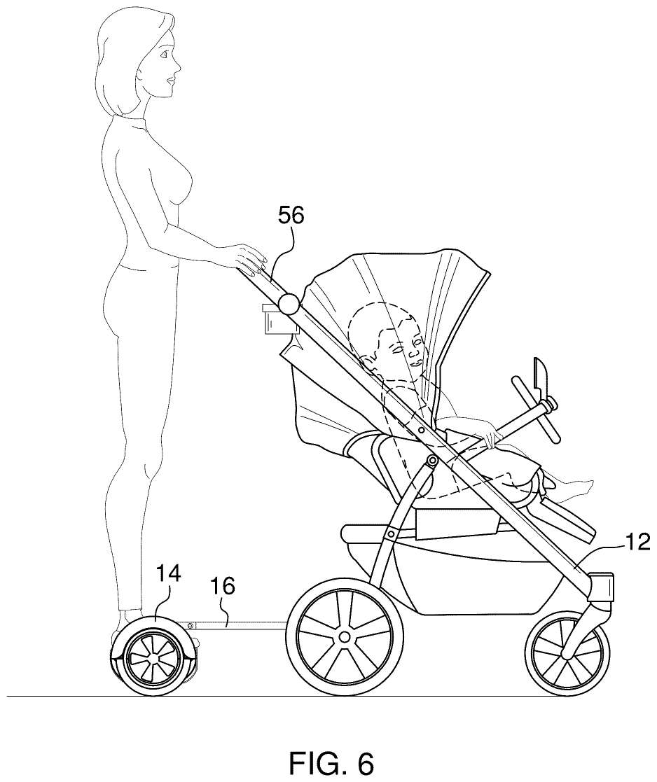

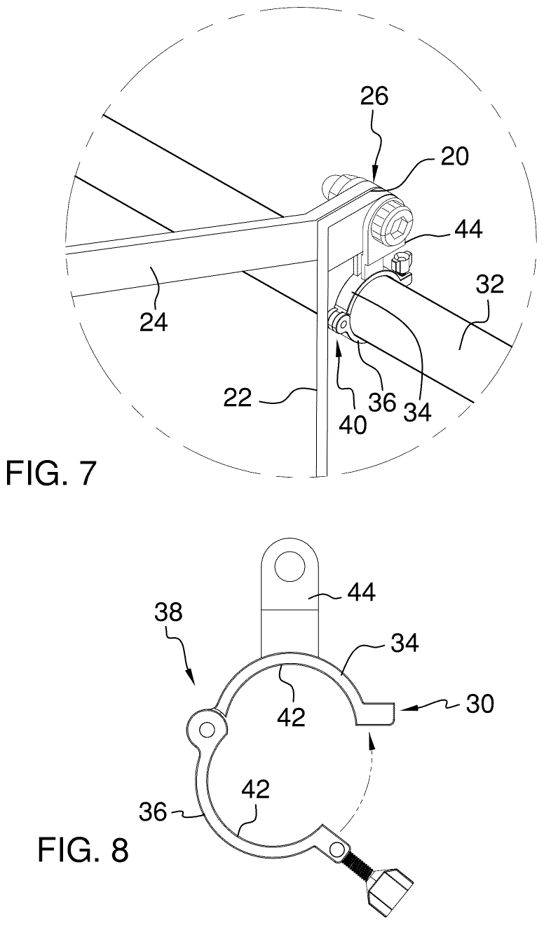

With reference now to the drawings, and in particular to FIGS. 1 through 8 thereof, a new stroller device embodying the principles and concepts of an embodiment of the disclosure and generally designated by the reference numeral 10 will be described. As best illustrated in FIGS. 1 through 8, the motorized stroller device 10 generally comprises a stroller 12 and a hoverboard 14. The stroller 12 may be of conventional design and include accessories known and provided on existing strollers. in a conventional manner moves the stroller 12 with the hoverboard 14.

A brace 16 has a first end 18 coupled to the hoverboard 14 and a second end 20 coupled to the stroller 12. The brace 16 includes a first beam 22 and a second beam 24. The first beam 22 and the second beam 24 are coupled together to define a junction 26 of the first beam 22 and the second beam 24 at the second end 20 of the brace 16. The first beam 22 and the second beam 24 extend from the junction 26 at an angle 28 relative to each other such that the first beam 22 and the second beam 24 are spaced from each other at the first end 18 of the brace 16. The angle 28 is an acute angle for spacing the hoverboard 14 behind the stroller 12.

A clamp 30 is removably coupled to a rear axle 32 of the stroller 12. The clamp 30 may be positioned at a center of the rear axle 32. The second end 20 of the brace 16 is coupled to the clamp 30 such that the clamp 30 secures the second end 20 of the brace 16 to the stroller 12. The clamp 30 includes an upper section 34 and a lower section 36 pivotally coupled to the upper section 34. Thus, the clamp 30 is pivotable between an open position 38 and a closed position 40. Each of the upper section 34 and the lower section 36 have complementary arcuate surfaces 42 positioned to frictionally engage the rear axle 32 of the stroller 12 in the closed position 40. A yoke 44 is coupled to and extends from the upper section 34 of the clamp 30. The brace 16 is coupled to the yoke 44 at the junction 26 to engage the brace 16 to the rear axle 32 of the stroller 12.

Each of a pair of flanges 48 is coupled to and extends from the hoverboard 14. Each of the first beam 22 and the second beam 24 is coupled to a respective one of the pair of flanges 48 such that the brace 16 is secured to the hoverboard 14. The pair of flanges 48 is spaced apart on the hoverboard 14 such that each flange 48 is positioned adjacent a respective lateral side 50 of the hoverboard 14. As noted previously, the hoverboard 14 is of substantially conventional design but for the flanges 48 being positioned on structure of the hoverboard which does not pivot as the hoverboard is operated.

A pair of straps 52 may be coupled to the hoverboard 14 for connection to a tether or strap to facilitate lifting and transport of the hoverboard 14 when the brace 16 is detached from the stroller 12.

In use, the hoverboard 14 is coupled to the stroller 12 using the brace 16. The clamp 30 is opened for insertion of the rear axle 32 into the clamp 30. The clamp 30 is closed and secured to the rear axle 32. The hoverboard 14 is thusly positioned behind the stroller 12 allowing a user to stand on the hoverboard 14 in convention fashion with a handle 56 of the stroller 12 immediately adjacent to the user. Operation of the hoverboard 14 moves the hoverboard 14 in a conventional manner with the brace 16 transferring force to the stroller 12 such that the stroller 12 is moved by the movement of the hoverboard 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorized stroller device comprising:
a stroller; and
a hoverboard, said hoverboard being coupled to said stroller wherein operation of said hoverboard moves said stroller with said hoverboard.

2. The motorized stroller device of claim 1, further comprising:
a brace having a first end coupled to said hoverboard and a second end coupled to said stroller.

3. The motorized stroller device of claim 2, further comprising said brace comprising a first beam and a second beam, said first beam and said second beam being coupled together to define a junction of said first beam and said second beam at said second end of said brace.

4. The motorized stroller device of claim 3, further comprising said first beam and said second beam extending from said junction at an angle relative to each other such that said first beam and said second beam are spaced from each other at said first end of said brace.

5. The motorized stroller device of claim 4, further comprising said angle being an acute angle.

6. The motorized stroller device of claim 2, further comprising a clamp, said clamp being removably coupled to a rear axle of said stroller, said second end of said brace being coupled to said clamp wherein said clamp secures said second end of said brace to said stroller.

7. The motorized stroller device of claim 3, further comprising a pair of flanges, each of said flanges being coupled to and extending from said hoverboard, each of said first beam and said second beam being coupled to a respective one of said pair of flanges wherein said brace is secured to said hoverboard.

8. The motorized stroller device of claim 7, further comprising said pair of flanges being spaced apart on said hoverboard such that each flange is positioned adjacent a respective lateral side of said hoverboard.

9. The motorized stroller device of claim 1, further comprising a pair of straps coupled to said hoverboard.

10. The motorized stroller device of claim 6, wherein said clamp comprises:
an upper section;
a lower section pivotally coupled to said upper section wherein said clamp is pivotable between an open position and a closed position, each of said upper section and said lower section having complementary arcuate surfaces positioned to frictionally engage said axle of said stroller in said closed position.

11. The motorized stroller device of claim 10, further comprising a yoke coupled to and extending from said upper section of said clamp, said brace being coupled to said yoke to engage said brace to said axle of said stroller.

12. A motorized stroller device comprising:
a stroller;
a hoverboard, said hoverboard being coupled to said stroller wherein operation of said hoverboard moves said stroller with said hoverboard;
a brace having a first end coupled to said hoverboard and a second end coupled to said stroller, said brace comprising a first beam and a second beam, said first beam and said second beam being coupled together to define a junction of said first beam and said second beam at said second end of said brace, said first beam and said second beam extending from said junction at an angle relative to each other such that said first beam and said second beam are spaced from each other at said first end of said brace, said angle being an acute angle;
a clamp, said clamp being removably coupled to a rear axle of said stroller, said second end of said brace being coupled to said clamp wherein said clamp secures said second end of said brace to said stroller, wherein said clamp comprises:
an upper section;
a lower section pivotally coupled to said upper section wherein said clamp is pivotable between an open position and a closed position, each of said upper section and said lower section having complementary arcuate surfaces positioned to frictionally engage said axle of said stroller in said closed position;
a yoke coupled to and extending from said upper section of said clamp, said brace being coupled to said yoke to engage said brace to said axle of said stroller;
a pair of flanges, each of said flanges being coupled to and extending from said hoverboard, each of said first beam and said second beam being coupled to a respective one of said pair of flanges wherein said brace is secured to said hoverboard, said pair of flanges being spaced apart on said hoverboard such that each flange is positioned adjacent a respective lateral side of said hoverboard; and
a pair of straps coupled to said hoverboard.
